(19) United States
(12) Patent Application Publication
(10) Pub. No.: US 2026/0145885 A1
(43) Pub. Date: May 28, 2026

(54) METHOD FOR CONTROLLING A CONVEYING DEVICE FOR FEEDING A PLASTIC WASTE MIXTURE STREAM TO A PLASTIC RECYCLING PLANT, AND A CORRESPONDING DEVICE

(71) Applicant: GRANNEX GMBH & CO. KG, Osnabrück (DE)

(72) Inventors: Markus BÖRGER, Osnabrück (DE); Andreas STOLZENBERG, Schwanewede (DE); Thomas MERTENS, Osnabrück (DE)

(21) Appl. No.: 19/121,175

(22) PCT Filed: Oct. 17, 2022
(86) PCT No.: PCT/DE2022/100763

§ 371 Date: Apr. 15, 2025

(51) Int. Cl. B65G 43/08; B29B 17/04; B65G 15/00; G01N 9/00

(52) U.S. Cl. CPC B65G 43/08; G01N 9/00; B29B 17/0412; B65G 15/00; B65G 2201/04; B65G 2203/0258; B65G 2203/041; B65G 2811/095; B65G 2814/0258; B65G 2814/0314; B65G 2814/0344

(57) ABSTRACT

A method for controlling a conveying device for feeding a plastic waste mixture stream to a plastic recycling plant; conveying a plastic waste mixture stream at a feed speed, wherein the plastic waste mixture stream has a variable proportion of 2D material, a variable proportion of 3D material and a variable bulk density, wherein the proportions and the bulk density vary over time; detecting at least one parameter of the conveyed plastic waste mixture stream; determining the bulk density of the plastic waste mixture stream on the basis of the at least one detected parameter; controlling the feed speed as a function of the determined bulk density. The invention furthermore relates to a corresponding device.

### CROSS-REFERENCE TO RELATED APPLICATIONS

This application is a U.S. National Phase Application under 35 U.S.C. 371 of International Application No. PCT/DE2022/100763, filed on Oct. 17, 2022. The entire disclosure of the above application is incorporated herein by reference.

### BACKGROUND

This section provides background information related to the present disclosure which is not necessarily prior art.

### Technical Field

The invention is based on a method or a device for controlling a conveying device for feeding a plastic waste stream to a plastic separation plant, comprising the conveying of a plastic waste stream at a feed speed, detecting the volume density of the conveyed plastic waste stream, and controlling the feed speed as a function of the detected volume density.

### Discussion

Increasing quantities of plastic waste pose enormous challenges to our society in the coming years. In 2019, around 5.35 million tons of post-consumer plastic waste were produced in Germany. Of these, only 1.33 million tons were fed to material recycling in processing plants within Germany. From this, in turn, only 1.03 million tons of output were produced in a quality which is suitable for reuse in the plastics processing industry. This corresponds to a quota of just over 19%.

As of today, some countries not have the necessary recycling infrastructure to process the quantities of plastic waste produced economically and technically into high-quality recycled products. Many processing plants today do not correspond to the state of the art, are obsolete and have a very weak economic foundation.

Increasing quantities of plastic waste, tightened national and international legislation on authorization procedures and to increase recycling quotas and the use of recycled products and restrictions on the import and export of waste pose enormous challenges for the EU Member States and in particular plastic recycling companies in the coming years. Investment in processing capacity and in particular the development of new processing methods to solve the described challenges and problems are urgently needed.

One of the greatest challenges for plastic recyclers is highly contaminated plastic waste mixtures. With existing recycling processes & plants, these fractions are currently being processed only to a very limited extent. A large part of this waste is therefore currently finding its way into thermal recycling. In addition, a large part of the recycled products produced does not allow stable plastic processing processes because of qualitative deficiencies and therefore rarely replaces new products in a sustainable manner in technically demanding plastic products.

The present situation demands new approaches for processing and creating additional capacity in order to achieve the requirements already in force today from, inter alia, VerpackG & KrWG, to increase material quotas in a sustainable manner and in order to provide plastic recycled products in the future in sufficient quantity and in particular of high, constant quality of the plastics processing industry as a substitute for primary plastics.

The development of economically viable concepts for processing materials for highly contaminated and mixed quantities of plastic waste, which have previously been predominantly thermally recycled, is critical. New and modern processing technology has great potential to meet recycling quotas and, inter alia, to avoid levies on plastic waste mixtures not recycled in Germany so far and to reduce a further economic and ecological burden by quantities of plastic waste not recycled materially.

Plastics are often collected in a mixed manner but are fed to the reprocessing only after passing through complex dry-mechanical separation steps such as, for example, ballistics separators or NIR sorters. However, because films, bags and trays, so-called 2D materials, can only be poorly cleaned and separated from other types of plastic in these existing methods and plants, they are largely not fed to the reprocessing, but are lost for recycling. These sorting residues not recycled materially are therefore recycled energetically and the thermal energy contained is used to provide electricity and district heating.

A method for separating and recovering plastics is known from DE 10 2013 213 478 A1, wherein the plastics have a similar density. For the separation process, plastic particles are transported with a transport belt to a detection unit. The speed of the transport belt is regulated in such a way that a distance between the plastic particles which is advantageous for the subsequent separation is achieved, since particles which are too dense have a negative effect on the sorting result and the type purity of the desired plastic batches. The particle density on the transport belt is detected by means of a camera and processed by a computer program which is installed on a control unit and correspondingly regulates the speed of the transport belt.

However, the disclosed method has the disadvantage that, in the case thereof, the conveyed waste volume flow is detected by means of detection of the particle density on the transport belt, but not the bulk density of the conveyed plastic waste. Therefore, the method is not suitable for separating plastics having a wide range of different densities, and therefore in particular not for the simultaneous processing of 2D and 3D materials.

### SUMMARY

This section provides a general summary of the disclosure and is not a comprehensive disclosure of its full scope or all of its features.

The invention is therefore based on the objective technical aspect of further developing a method and a device for feeding a plastic waste mixture stream in such a way that plastics having different densities can be processed therewith, and a higher yield of valuable materials and a distinctly increased type purity can be achieved in the recycled products produced from plastic waste mixtures.

Accordingly, it is provided that the method for controlling a conveying device for feeding a plastic waste mixture stream to a plastic recycling plant comprises:
conveying a plastic waste mixture stream at a feed speed, wherein the plastic waste mixture stream has a variable proportion of 2D material, a variable proportion of 3D material and a variable bulk density, wherein the proportions and the bulk density vary over time;
detecting at least one parameter of the conveyed plastic waste mixture stream;
determining the bulk density of the plastic waste mixture stream on the basis of the at least one detected parameter;
controlling the feed speed as a function of the determined bulk density.

The provision of a plastic waste mixture stream having variable proportions of 2D and 3D material can imply that the fed plastic waste mixture stream is distinctly more heterogeneous than conventional methods and, above all, can also be subject to great fluctuations with regard to the individual proportions when viewed over time. In particular, it can be provided that the 3D proportion comprises bulky plastic wastes such as hollow bodies and the 2D proportion comprises flat plastic wastes such as films.

The method according to the invention therefore has the advantage that it can process a plastic waste mixture stream having fluctuating 2D/3D proportions in input. The joint processing of 2D and 3D materials in this case leads to a distinctly higher yield of all valuable material components for material recycling than the method known from the state of the art. Therefore, the method according to the invention can be used in particular for plants by means of which both HDPE (high density polyethylene) ground material, PP (polypropylene) ground material and a PO (polyolefin) film ground material and different types of polymers or thermoplastic can be obtained.

It can be provided that the feed speed is controlled in such a way that the feed speed is low at a low determined bulk density and high at a high determined bulk density. Therefore, the feed speed can be controlled proportionally to the determined bulk density. This is because sorting of 2D and 3D plastic waste mixtures is all the more effective at a disproportionate proportion of 2D material, the lower the gram/liter ratio. This means that when a high 2D proportion is detected in the plastic waste mixture stream, the feed speed is reduced so that the individual types of plastic can be separated from one another with a constantly high degree of separation in the downstream plastic recycling plant.

It is conceivable that the detection of the at least one parameter comprises the detection of the mass flow of the conveyed plastic waste mixture stream, for example by means of a belt weigher.

Furthermore, the detection of the at least one parameter can comprise an in particular continuous optical detection of the composition of the conveyed plastic waste mixture stream, for example by means of a line camera. In this case, the bulk density can be determined on the basis of the optically detected ratio of the 2D material portion to the 3D material portion in the plastic waste mixture stream, since 2D materials have on average a lower bulk density than 3D materials. This means that the bulk density correlates with the 2D or the 3D proportion in the plastic waste mixture stream. The bulk density can be, for example, between 10 grams/liter at a very high 2D material portion and 400 grams/liter at a very high 3D material portion.

Furthermore, the determination of the bulk density can comprise a comparison of the optically detected ratio of the 2D material portion to the 3D material portion in the conveyed plastic waste mixture stream with reference images stored in a database. The database can be stored on a memory of the control unit. The reference images stored in the database can each be assigned a target conveying speed which is used for controlling the feed speed. The assigned target conveying speed can be low in reference images with a high 2D portion and high in reference images with a low 2D portion.

It can be provided that the method further comprises the levelling of the plastic waste mixture stream to a predefined height before the detection of the at least one parameter of the conveyed plastic waste mixture stream. In this case, the plastic waste mixture can be conveyed for example in the form of a monolayer on the transport belt. By avoiding peaks on the transport belt, better image recognition can be achieved. For example, the levelling of the plastic waste mixture stream can be carried out by means of a vibrating device before the detection of the at least one parameter of the conveyed plastic waste mixture stream. Furthermore, the conveying of the plastic waste mixture stream can take place by means of a transport means, for example a transport belt or a vibrator, wherein the loading of the transport means with plastic waste can take place by means of a plurality of separate waste chutes which are arranged next to one another perpendicularly to the conveying direction of the transport means and via which the transport means can be loaded over its entire width.

Furthermore, the method can comprise the comminution of the plastic waste mixture to a predetermined material size before the conveying of the plastic waste mixture stream. By homogenizing the plastic parts to a predetermined size, an easier determination of the 2D proportion or 3D proportion can take place, since in this case recurring patterns of specific proportion quantities become better visible.

It can be provided that the control of the feed speed comprises the control of the feed speed of the plastic waste mixture stream onto the transport means. Furthermore, the control of the feed speed can comprise the control of the conveying speed of the transport means.

The invention furthermore relates to a conveying device for carrying out the method according to any one of the preceding claims, comprising a feed device which comprises a transport means, in particular a conveyor belt, for feeding the plastic waste mixture stream; a detection device for detecting at least one parameter of the plastic waste mixture stream located on the transport means, a control unit which is configured to control the feed speed of the feed device, wherein the control unit is configured to determine the bulk density of the plastic waste mixture stream on the basis of the at least one detected parameter and to control the feed speed of the feed device as a function of the determined bulk density.

In this case, the feed speed can be controlled in such a way that the feed speed is low at a low determined bulk density and high at a high determined bulk density.

Furthermore, the detection device can comprise a belt weigher for detecting the mass flow of the plastic waste mixture located on the transport means.

Furthermore, the detection device can comprise an optical detection means, for example a line camera, for detecting the composition of the plastic waste mixture stream located on the transport means.

The control unit can be configured to determine the bulk density on the basis of the optically detected ratio of the 2D material portion to the 3D material portion in the plastic waste mixture stream.

The control unit can furthermore be configured to compare the optically detected ratio of the 2D material portion to the 3D material portion in the conveyed plastic waste mixture stream with reference images stored in a database in order to determine the bulk density. In this case, the reference images stored in the database can each be assigned a target conveying speed which is used for controlling the feed speed. The assigned target conveying speed can be low in reference images with a high 2D portion and high in reference images with a low 2D portion.

The feed device can furthermore comprise a feed device for feeding the plastic waste mixture stream onto the conveyor belt. The feed device can comprise a plurality of separate waste chutes which are arranged next to one another perpendicularly to the conveying direction of the transport means and via which the transport means can be loaded over its entire width. In addition, the feed device can furthermore comprise a device for levelling the plastic waste mixture stream. The device for levelling the plastic waste mixture stream can comprise a height limiting device which crosses the conveying path and is arranged above a transport surface of the transport means and is configured to limit the passing plastic waste mixture stream to a predefined height. The device for levelling the plastic waste mixture stream can furthermore be configured such that the transport means is of trough-shaped configuration and comprises a vibrating device for vibrating levelling of the plastic waste mixture stream.

Furthermore, a comminution device for comminuting the plastic waste mixture can be connected upstream of the feed device and is configured to comminute the plastic waste mixture to a predetermined material size.

The control of the feed speed can comprise the control of the feed speed of the plastic waste mixture stream from the feed device onto the transport means. The control of the feed speed can comprise the control of the conveying speed of the transport means. Furthermore, the control of the conveying speed of the transport means can be effected by means of a frequency converter. The motor of the transport means can be configured as a three-phase motor.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Further details of the invention will be explained based on the following figures. In the figures:

FIG. 1 shows a schematic representation of an embodiment of the conveying device according to the invention; and

FIG. 2 shows a flow chart of an embodiment of the method according to the invention.

### DETAILED DESCRIPTION

Example embodiments will now be described more fully with reference to the accompanying drawings.

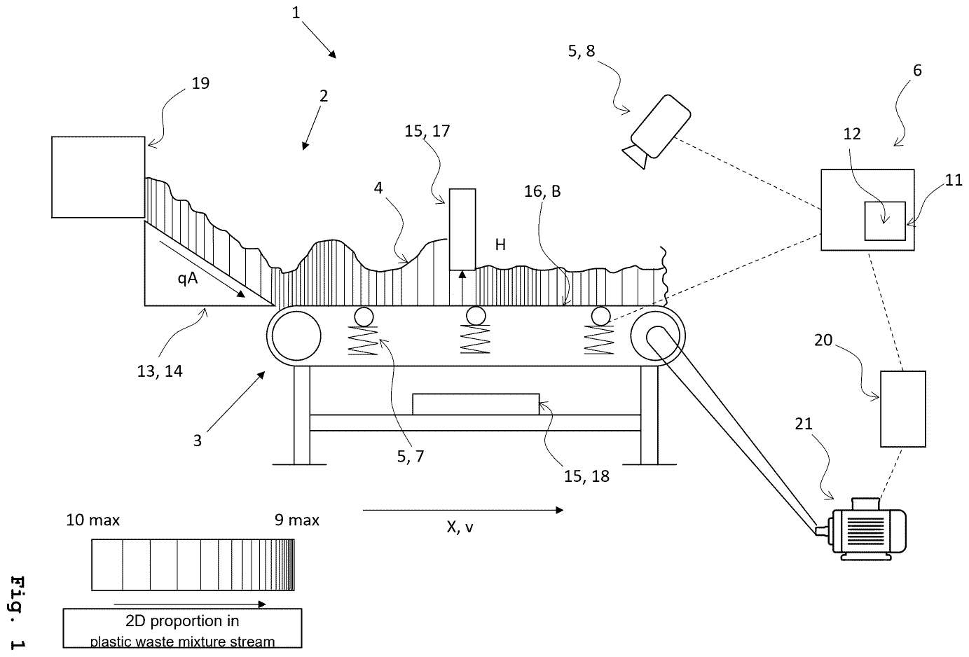

The conveying device 1 shown in FIG. 1 for feeding a plastic waste mixture stream 4 to a plastic recycling plant essentially has a feeding device 2, a detection unit 5, a control unit 6, and a drive 21. The feeding device 2 comprises a feed device 13 and a transport means 3. By means of the feed device 13, a plastic waste mixture stream 4 is fed onto the transport means 3 on the input side. In the embodiment shown, the feed device 13 comprises a plurality of separate waste chutes 14 which are arranged next to one another perpendicularly to the conveying direction X of the transport means 3 and via which the transport means 3 is loaded over its entire width B. By setting the feed volume flow q_{A}, it is possible to adjust the amount of waste per unit time which is fed onto the transport means 3. This can be effected by means of setting a speed of a feed conveying means of the feed device 13 and/or by changing a passage cross section of the feed device 13, for example by means of a bulkhead. Before the transfer of the plastic waste onto the feed device 13, the waste can be comminuted to a predetermined material chip size by means of a comminution device 19. In the embodiment shown, the transport means 3 is configured as a belt conveyor. The plastic waste mixture stream 4 has both a 2D material portion 9 and a 3D material portion 10, wherein the proportions vary within the plastic waste mixture stream 4, which is made clear by the hatching of different strengths in accordance with the adjacent diagram. This means that the 2D proportion is lowest in regions with little or no hatching and is maximum in regions with strong hatching. When the transport means 3 is reached, the plastic waste mixture stream 4 can have an inconstant height which is caused by the formation of regions with accumulations of waste and regions with lower waste loading. This is made clear in FIG. 1 by the height profile of the waste mixture stream 4 in the mouth region of the transport means. For levelling the accumulations, the conveying device 1 comprises, on the one hand, a height limiting device 17 which crosses the conveying path X and is arranged above the transport surface 16 of the transport means 3 and by means of which the waste mixture stream 4 is limited to a predefined height H, whereby the subsequent detection of the composition of the plastic waste mixture stream 4 is facilitated. The height limiting device 17 can be of height-adjustable configuration. As a further device 15 for levelling the plastic waste mixture stream 4, the transport means 3 comprises a vibrating device 18 by means of which the transport surface 16 or the plastic waste mixture stream 4 can be vibrated, such that unevennesses which are likewise present can thereby be leveled.

After passing the height limiting device 17, the plastic waste mixture stream 4 has an essentially constant height H, as shown. At least one parameter of the plastic waste mixture stream 4 is then detected by means of a detection device 5. The detection device 5 can comprise a weight detection device such as, for example, a belt weigher 7 by means of which the weight of the plastic waste mixture stream 4 is constantly detected. The detection device 5 can furthermore comprise an optical detection device 8 such as a line camera. The latter detects the surface of the plastic waste mixture stream 4 for optical detection of the composition of the plastic waste mixture stream 4, in particular for detection of the 2D proportion and the 3D proportion, which each correlate with a specific bulk density. The detection device 5, that is to say the belt weigher 7 and the camera 8, are connected to a control unit 6 and transmit the detected information to the latter. The control unit 6 determines the current bulk density of the plastic waste mixture stream 4 located on the transport means 3 from the information received. In the case of optical detection, the control unit 6 comprises a database 11 in which reference images 12 are stored. The control unit compares the images detected by the camera with the reference images 12 stored in the database 11 and determines which of the reference images 12 is most similar to the image currently detected by means of the camera 8. In this case, a target conveying speed v_{S} is assigned to each reference image 12. With this target conveying speed v_{S}, the control unit 6 controls a drive 21 which drives the transport means 3, wherein the feed speed v thereof is adapted to the determined target conveying speed vs in the course thereof. In the embodiment shown, the control of the speed of the transport means 3 is effected by means of a frequency converter 20 which is interposed between the control unit 6 and the drive 21 of the transport means 3.

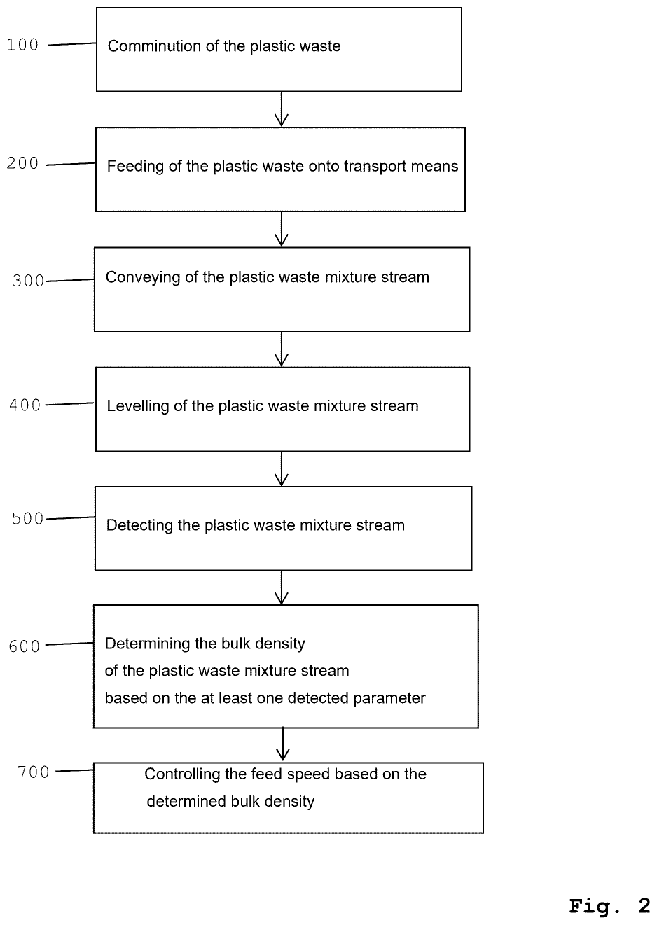

FIG. 2 shows a flow chart of an embodiment of the method according to the invention. In this case, the comminution of plastic waste to a predetermined material chip size is effected in a first step 100. Subsequently, in a second step 200, the plastic waste is fed onto a transport means 3 which conveys 300 the plastic waste mixture stream 4 at a feed speed v in along a conveying direction X. The plastic waste mixture stream 4 conveyed on the transport means 3 is then leveled 400 by means of a suitable device in order to limit it to a predetermined height H. After the levelling 400, at least one parameter of the plastic waste mixture stream 4 located on the transport means 3 is detected 500 and transmitted to a control unit 6 which determines 600 the bulk density of the plastic waste mixture stream 4 from the at least one detected parameter. Finally, the feed speed v of the transport means 3 is controlled 700 on the basis of the determined bulk density.

The features of the invention disclosed in the above description, in the drawings and in the claims can be essential both individually and in any combination for the realization of the invention.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1-32. (canceled)

33. A method for controlling a conveying device for feeding a plastic waste mixture stream to a plastic recycling plant; the method comprising:
conveying a plastic waste mixture stream on a the transport means at a feed speed, wherein the plastic waste mixture stream has a variable proportion of 2D material, a variable proportion of 3D material and a variable bulk density, wherein the proportions and the bulk density vary over time;
detecting at least one parameter of the plastic waste mixture stream conveyed on the transport means, wherein before the detection of the at least one parameter of the conveyed plastic waste mixture stream the plastic waste mixture stream is levelled to a predefined height;
determining the bulk density of the plastic waste mixture stream on the basis of the at least one detected parameter;
controlling the feed speed as a function of the determined bulk density.

34. The method according to claim 33, wherein the feed speed is controlled in such a way that the feed speed is low at a low determined bulk density and high at a high determined bulk density.

35. The method according to claim 33, wherein the detection of the at least one parameter comprises the detection of the mass flow of the conveyed plastic waste mixture stream, for example by means of a belt weigher.

36. The method according to claim 33, wherein the detection of the at least one parameter comprises an optical detection of the composition of the conveyed plastic waste mixture stream, for example by means of a line camera.

37. The method according to claim 36, wherein the bulk density is determined on the basis of the optically detected ratio of the 2D material portion to the 3D material portion in the plastic waste mixture stream.

38. The method according to claim 36, wherein the determination of the bulk density comprises a comparison of the optically detected ratio of the 2D material portion to the 3D material portion in the conveyed plastic waste mixture stream with reference images stored in a database.

39. The method according to claim 38, wherein the reference images stored in the database are each assigned a target conveying speed which is used for controlling the feed speed.

40. The method according to claim 39, wherein the assigned target conveying speed is low in reference images with a high 2D portion and high in reference images with a low 2D portion.

41. The method according to claim 33, wherein the bulk density is between 10 grams/liter and 400 grams/liter.

42. The method according to claim 33, further comprising the levelling of the plastic waste mixture stream by means of a vibrating device, preferably a vibrator, before the detection of the at least one parameter of the conveyed plastic waste mixture stream.

43. The method according to claim 33, further comprising the conveying of the plastic waste mixture stream by means of a transport means, wherein the loading of the transport means with plastic waste takes place by means of a plurality of separate waste chutes which are arranged next to one another perpendicularly to the conveying direction of the transport means and via which the transport means is loaded over its entire width.

44. The method according to claim 33, further comprising the comminution of the plastic waste mixture to a predetermined material size before the conveying of the plastic waste mixture stream.

45. The method according to claim 43, wherein the control of the feed speed comprises the control of the feed speed of the plastic waste mixture stream onto the transport means.

46. The method according to claim 42, wherein the control of the feed speed comprises the control of the conveying speed of the transport means.

47. A conveying device for carrying out the method according to claim 33, comprising:
a feed device which comprises a transport means, in particular a conveyor belt, for feeding the plastic waste mixture stream;
a detection device for detecting at least one parameter of the plastic waste mixture stream located on the transport means,
a control unit which is configured to control the feed speed of the feed device,
wherein the feed device further comprises a device for levelling the plastic waste mixture stream, and the control unit is configured to determine the bulk density of the plastic waste mixture stream on the basis of the at least one detected parameter and to control the feed speed of the feed device as a function of the determined bulk density.

48. The conveying device according to claim 47, wherein the feed speed is controlled in such a way that the feed speed is low at a low determined bulk density and high at a high determined bulk density.

49. The conveying device according to claim 47, wherein the detection device comprises a belt weigher for detecting the mass flow of the plastic waste mixture located on the transport means.

50. The conveying device according to claim 47, wherein the detection device comprises an optical detection means, for example a line camera, for detecting the composition of the plastic waste mixture stream located on the transport means.

51. The conveying device according to claim 50, wherein the control unit is configured to determine the bulk density on the basis of the optically detected ratio of the 2D material portion to the 3D material portion in the plastic waste mixture stream.

52. The conveying device according to claim 50, wherein the control unit is configured to compare the optically detected ratio of the 2D material portion to the 3D material portion in the conveyed plastic waste mixture stream with reference images stored in a database in order to determine the bulk density.

53. The conveying device according to claim 52, wherein the reference images stored in the database are each assigned a target conveying speed which is used for controlling the feed speed.

54. The conveying device according to claim 53, wherein the assigned target conveying speed is low in reference images with a high 2D portion and high in reference images with a low 2D portion.

55. The conveying device according to claim 47, wherein the feed device further comprises a feed device for feeding the plastic waste mixture stream onto the conveyor belt.

56. The conveying device according to claim 55, wherein the feed device comprises a plurality of separate waste chutes which are arranged next to one another perpendicularly to the conveying direction of the transport means and via which the transport means can be loaded over its entire width (b).

57. The conveying device according to claim 47, wherein the device for levelling the plastic waste mixture stream comprises a height limiting device which crosses the conveying path and is arranged above a transport surface of the transport means and is configured to limit the passing plastic waste mixture stream to a predefined height.

58. The conveying device according to claim 47, wherein the device for levelling the plastic waste mixture stream is further configured such that the transport means is of trough-shaped configuration and comprises a vibrating device for vibrating levelling of the plastic waste mixture stream.

59. The conveying device according to claim 47, wherein a comminution device for comminuting the plastic waste mixture is connected upstream of the feed device and is configured to comminute the plastic waste mixture to a predetermined material size.

60. The conveying device according to claim 55, wherein the control of the feed speed comprises the control of the feed speed of the plastic waste mixture stream from the feed device onto the transport means.

61. The conveying device according to claim 47, wherein the control of the feed speed comprises the control of the conveying speed of the transport means.

62. The conveying device according to claim 61, wherein the control of the conveying speed of the transport means is effected by means of a frequency converter.
